(19) United States
(12) Patent Application Publication
(10) Pub. No.: US 2023/0398827 A1
(43) Pub. Date: Dec. 14, 2023

(54) TOP MOUNT HOUSING, ASSEMBLY, AND METHOD

(71) Applicant: Vibracoustic USA, Inc., South Haven, MI (US)

(72) Inventor: Nicolas J. Fricke, Holland, MI (US)

(21) Appl. No.: 17/838,444

(22) Filed: Jun. 13, 2022

(51) Int. Cl. B60G 15/06; B60G 13/00; B60G 11/24

(52) U.S. Cl. CPC B60G 15/067; B60G 13/003; B60G 11/24; B60G 2206/80; B60G 2202/143; B60G 2204/125; B60G 2204/128; B60G 2800/162

(57) ABSTRACT

A top mount housing, suitable for an assembly including a jounce bumper and a damper mount, comprises a central annular portion having an upper portion, a lower cylindrical inner portion, and a central longitudinal axis. In embodiments, the lower cylindrical inner portion is configured to receive a portion of a jounce bumper, a lower lip portion extends from or is adjacent to the lower cylindrical inner portion, the lower cylindrical inner portion has a vertical length in the direction of the central longitudinal axis, and the lower lip portion is formed to extend radially inwardly at an angle from an imaginary line that is perpendicular to the central longitudinal axis. Methods for making a top mount and a top mount assembly are also disclosed.

### TECHNICAL FIELD

The present disclosure generally relates to top mount housings and assemblies, including those suitable for use in connection with a jounce bumper and a damper mount for a vehicle, as well as methods for making such components and assemblies.

### BACKGROUND

This background description is set forth below for the purpose of providing context only. Therefore, any aspect of this background description, to the extent that it does not otherwise qualify as prior art, is neither expressly nor impliedly admitted as prior art against the instant disclosure.

To improve noise, vibration, and harshness (NVH), top mount assemblies and modules may be employed in vehicles. Such assemblies and modules may, among other things, help vehicles with space, weight, and cost savings while consolidating elements associated with a strut function. Those of skill in the art, seek methods to help with the seating of jounce bumpers in top mounts in secure and efficient manners that, among other things, seek to reduce costs associated with machining and to simplify tooling and processes associated with top mount housings and related assemblies.

There is a desire for solutions and/or options that minimize or eliminate one or more challenges or shortcomings of conventional top mount housings and assemblies. The foregoing discussion is intended only to illustrate examples of the present field and is not a disavowal of scope.

### SUMMARY

In embodiments, a top mount housing, which is suitable for an assembly including a jounce bumper and a damper mount, includes a central annular portion having an upper portion, a lower cylindrical inner portion, and a central longitudinal axis. In embodiments, the lower cylindrical inner portion is configured to receive a portion of a jounce bumper, the lower cylindrical inner portion is adjacent a lower lip portion, the lower cylindrical inner portion has a vertical length in the direction of the central longitudinal axis, and the lower lip portion is formed to extend radially inwardly at an angle from an imaginary line that is perpendicular to the central longitudinal axis.

Methods for making a top mount and a top mount assembly are also disclosed.

The foregoing and other potential aspects, features, details, utilities, and/or advantages of examples/embodiments of the present disclosure will be apparent from reading the following description, and from reviewing the accompanying drawings.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is a cross sectional view generally illustrating an embodiment of a top mount housing in accordance with aspects and/or teachings of the present disclosure.

FIG. 2 is a cross sectional view generally illustrating an embodiment of a top mount housing, a portion of a jounce bumper, and a damper mount in accordance with aspects and/or teachings of the present disclosure.

FIG. 3 is a schematic cross sectional view generally illustrating an embodiment of a rolling process—shown prior to a tool engaging or forming the lower lip portion of a top mount.

FIG. 4 is a schematic cross sectional view generally illustrating an embodiment of a rolling process—shown with a tool engaging the lower lip portion of a top mount.

### DETAILED DESCRIPTION

Reference will now be made in detail to embodiments of the present disclosure, examples of which are described herein and illustrated in the accompanying drawings. While the present disclosure will be described in conjunction with embodiments and/or examples, they do not limit the present disclosure to these embodiments and/or examples. On the contrary, the present disclosure covers alternatives, modifications, and equivalents.

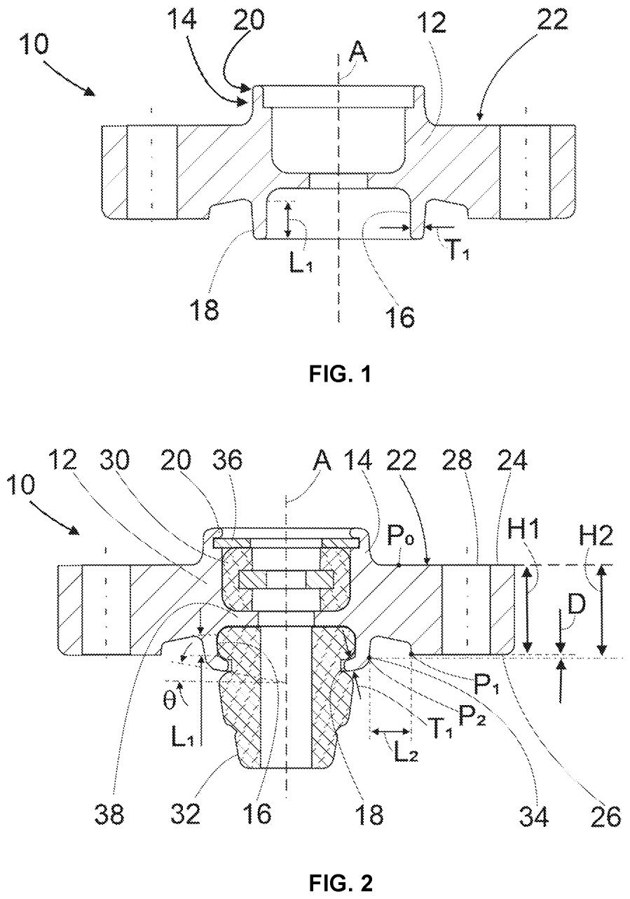

An embodiment of a top mount housing 10 accordance to aspects and/or teachings of the present disclosure is generally illustrated in FIG. 1. With embodiments, a top mount housing 10 may be configured for assembly with a jounce bumper and a damper mount. The top mount housing 10 may, for example and without limitation, be comprised of aluminum.

As generally illustrated, atop mount housing 10 may include, inter alia, a central annular portion 12, an upper portion 14, a lower cylindrical inner portion 16, and a central longitudinal axis A. A lower lip portion 18 may extend from, or be adjacent to, the lower cylindrical inner portion 16. In embodiments, an upper portion 14 may include an upper lip portion 20 and/or may be configured to receive a bushing, such as an elastomeric bushing 30.

FIG. 1 generally illustrates an embodiment of a top mount housing 10 in which a lower lip portion 18 and an upper lip portion 20 are generally illustrated in a “pre-formed” position or configuration. In such a pre-formed position or configuration, the lower lip portion 18 and/or the upper lip portion 20 may for example, at least initially extend in a direction that is substantially parallel to the central longitudinal axis A.

With additional reference to FIG. 2, in embodiments the lower cylindrical inner portion 16 may be configured to receive a portion of a jounce bumper 32, the lower lip portion 18 may include a portion with a radial thickness T1, the lower cylindrical inner portion 16 may have a vertical length L1 in the direction of the central longitudinal axis A, and the lower lip portion 18 may be formed to extend radially inwardly at an angle θ from an imaginary line that is perpendicular to the central longitudinal axis. For example and without limitation, angle θ may be less than 45 degrees. With some embodiments, angle θ may be less than 25 degrees. With other embodiments, angle θ may be less than 10 degrees. With yet other embodiments, angle θ may even be at or very close to zero degrees (i.e., essentially perpendicular to the central vertical axis A). For some applications, such angle θ may be adjusted or tuned to help provide or modify characteristics associated with a top mount housing or related assembly, including NVH related characteristics.

Further, the forming or manipulating the lower lip portion 18—such as changing the structure from a “pre-formed” configuration (such as generally illustrated in FIG. 1) to a “formed” configuration (such as generally illustrated in FIG. 2)—may be accomplished without using or requiring a separate rigid part or component to provide direct contact or support with or to the lower cylindrical inner portion 16. That is, the formation of the lower lip portion 18 to a “formed” position may, for example, be accomplished without requiring an outer tube of a bushing or a support ring.

In embodiments, the vertical length L1 of the lower cylindrical inner portion 16 may be longer than a radial thickness T1 of the portion of the lower lip portion. Additionally, the lower cylindrical inner portion 14 may have a draft angle. With embodiments, the lower cylindrical inner portion 14 may have a draft angle less than 5 degrees, may have a draft angle less than 4 degrees, may have a draft angle less than 3 degrees, or may have a draft angle less than 2 degrees.

In embodiments, an upper lip portion 20 may be configured for forming (e.g., roll forming or shaping) to retain at least a portion of an upper component 36, e.g., a cap.

Moreover, embodiments of top mount housings may additionally include an extended portion 22. Some embodiments may include two or more extended portions. An extended portion 22 or plurality of extended portions may comprise a variety of shapes and configurations, including, for example and without limitation, e.g., a disk-shape that is configured to receive a plurality of screws. Moreover, with embodiments, an extended portion 22 may include a fastener 28, which may comprise, for example and without limitation, an aperture, a threaded insert, a threaded bolt, or combinations of two or more of the foregoing, as well as other known types or forms of fastening means.

With further reference to FIG. 2, a vertical distance or height (essentially parallel to the central longitudinal axis A) from a point P0 on an upper surface 24 of an outer radial portion of an extended portion 22 to a point P1 on a lower surface 26 of an outer radial portion of the extended portion 22 is generally identified as H1. Additionally, a vertical distance or height H2 may extend from a point P0 on an upper surface 24 of the extended portion 22 to an outer radial point (e.g., inflection point) P2 where, following forming, the lower lip portion 18 initially substantial curves or bends radially inwardly from a portion of the lower cylindrical inner portion 16 (which may generally remain parallel to the central longitudinal axis A). As generally illustrated, a vertical distance D (in the longitudinal direction) may be equal to height H2 minus height H1. Although, it is noted that with some alternative embodiments, height H2 may be less than or equal to height H1. In such instances, tooling may be adapted given such a configuration and possible limitations associated with radial access.

In embodiments, P1 may be a point where H1 reaches its maximum, and P2 may be a point on an outer radial inflection ring 34. In embodiments, P1 may be located anywhere within a radial distance L2 from a point P2 on the outer radial inflection ring 34. Further, with embodiments, L2 may, for example and without limitation, be about 3 cm.

With embodiments, vertical distance D may be defined to reduce or eliminate a risk of contact or collision between a tool (e.g., a roll forming tool) and the top mount housing 10. Vertical distance D may, for example and without limitation, be less than 2 cm and, with some embodiments, may be less than 1 cm. Further, with some embodiments, vertical distance D may be negative.

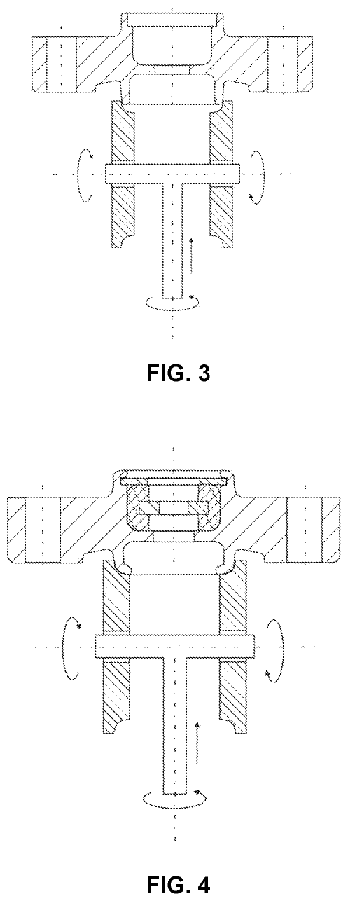

Methods for forming a top mount housing and methods for assembling a jounce bumper and a top mount are also contemplated and disclosed. For example, in connection with embodiments of the methods, FIGS. 3 and 4 include schematic cross section views that generally illustrate embodiments of a rolling process that may be used to form a top mount housing in accordance with aspects or teachings of the present disclosure. FIG. 3 generally illustrates a top mount housing shown prior to a tool engaging or forming a lower lip portion of the top mount. FIG. 4 generally illustrates a top mount housing that is shown with a tool engaging the lower lip portion of the top mount.

Methods for forming and assembling top mount housings (such as disclosed herein) and assemblies that include a jounce bumper and a jounce bumper seat (or sleeve) are contemplated by the present disclosure. A top mount housing associated with the methods may include a central annular portion 12 having an upper portion, an annular divider 38, a lower cylindrical inner portion 16, and a lower lip portion 18, wherein the lower cylindrical inner portion 16 may be configured to receive a portion of the jounce bumper seat. In embodiments, the top mount housing may be comprised of aluminum. In embodiments, the top mount housing may be comprised of a material that has been high pressure die cast or cold forged.

Such methods may involve forming the lower lip portion radially inwardly to provide a ledge or retaining portion (such as an undercut) with respect to the direction of the central longitudinal axis A and then pressing (e.g., snap pressing) or otherwise fitting a portion of a jounce bumper seat (e.g., a portion of an elastic jounce bumper seat) around or through the ledge or retaining portion formed by the lower lip portion 18 to thereby retain or lock in the portion of the jounce bumper seat such that the portion of the jounce bumper seat is retained by the lower lip portion 18 and the annular divider 38.

In embodiments of such methods, the forming step may comprise roll forming. Moreover, with embodiments, the forming may be performed without internally rigidly supporting the lower cylindrical inner portion 16. Further, with some embodiments, the upper portion may include an upper lip portion, and the upper lip portion may be roll formed to retain an upper component 36, such as a cap. In some embodiments, a damper mount may be included within the upper portion.

FIGS. 3 and 4 include schematic cross section views that generally illustrate embodiments of a rolling process that may be used to form a top mount housing in accordance with aspects or teachings of the present disclosure. FIG. 3 generally illustrates a top mount housing shown prior to a tool engaging or forming a lower lip portion of the top mount. FIG. 4 generally illustrates a top mount housing that is shown with a tool engaging the lower lip portion of the top mount.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. The use of “e.g.” and “such as” in the specification are to be construed broadly and are used to provide non-limiting examples of embodiments of the disclosure, and the disclosure is not limited to such examples or such types of examples. Uses of “and” and “or” are to be construed broadly (e.g., to be treated as “and/or”). For example and without limitation, uses of “and” do not necessarily require all elements or features listed, and uses of “or” are inclusive unless such a construction would be illogical.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

All matter contained in the above description or shown in the accompanying drawings shall be interpreted as illustrative only and not limiting. Changes in detail or structure may be made without departing from the present disclosure.

What is claimed is:

1. A top mount housing for a jounce bumper and a damper mount, comprising:
a central annular portion that includes an upper portion, a lower cylindrical inner portion, and a central longitudinal axis;
wherein the lower cylindrical inner portion is configured to receive a portion of a jounce bumper, a lower lip portion extends from or is adjacent to the lower cylindrical inner portion, the lower cylindrical inner portion has a vertical length in the direction of the central longitudinal axis, and the lower lip portion is formed to extend radially inwardly at an angle θ from an imaginary line that is perpendicular to the central longitudinal axis.

2. The top mount housing of claim 1, wherein the vertical length of the lower cylindrical inner portion is longer than a radial thickness of a portion of the lower lip portion.

3. The top mount housing of claim 1, wherein the lower cylindrical inner portion has a draft angle less than 5 degrees.

4. The top mount housing of claim 1, wherein the upper portion includes an upper lip portion configured for roll forming to retain an upper component.

5. The top mount housing of claim 1, including an extended portion and a fastener.

6. The top mount housing of claim 1, wherein a vertical distance D in the longitudinal direction is equal to a height H2 minus a height H1; wherein the height H2 extends parallel to the central longitudinal axis from a point P0 on an upper surface of the central annular portion to a point P2, and the height H1 extends parallel to the central longitudinal axis from the point P0 to a point P1; wherein the point P2 is a point on an outer radial inflection ring of the lower lip portion where the height H2 reaches its minimum and point P1 is the point where height H2 reaches its maximum; wherein point P1 is located within a distance of 3 cm radially outwardly directed from the outer radial inflection ring; and wherein the vertical distance D is less than 2 cm.

7. The top mount housing of claim 6, wherein the vertical distance D is less than 1 cm.

8. The top mount housing of claim 6, including an extended portion, wherein the extended portion has height H2 extending in a longitudinal direction from an upper surface to the point P2 on the outer radial inflection ring of the lower lip portion, and wherein height H2 is less than or equal to height H1.

9. The top mount housing of claim 1, wherein the upper portion is configured to receive an elastomeric bushing.

10. The top mount housing of claim 1, wherein the top mount housing is comprised of aluminum.

11. The top mount housing of claim 1, wherein angle θ is less than 45 degrees.

12. The top mount housing of claim 1, wherein angle θ is less than 10 degrees.

13. The top mount housing of claim 1, wherein in an assembled state of the top mount housing no rigid part is in direct contact to the lower cylindrical inner portion.

14. An assembly, comprising:
a top mount housing according to claim 1,
a molded damper mount including an elastomer, the molded damper mount disposed within the upper portion of the top mount housing;
a jounce bumper, a portion of the jounce bumper retained by the lower lip portion, and
a cap provided to cover at least a portion of the molded damper mount, the cap retained by an upper lip portion of the upper portion.

15. A method for assembling a jounce bumper and a top mount, comprising:
providing a jounce bumper and a jounce bumper seat;
providing a top mount housing including a central annular portion having an upper portion, an annular divider, a lower cylindrical inner portion, and a lower lip portion; the lower cylindrical inner portion configured to receive a portion of the jounce bumper seat;
forming the lower lip portion radially inwardly to provide a ledge or retaining portion with respect to the direction of the central longitudinal axis;
pressing or fitting a portion of the jounce bumper seat around or through the ledge or retaining portion formed by the lower lip portion, retaining or locking in the portion of the jounce bumper seat such that the portion of the jounce bumper seat is retained by the lower lip portion and the annular divider.

16. The method of claim 15, wherein the forming comprises roll forming.

17. The method of claim 15, wherein the forming is performed without internally rigidly supporting the lower cylindrical inner portion.

18. The method of claim 15, wherein the upper portion includes an upper lip portion, and the upper lip portion is roll formed to retain an upper component.

19. The method of claim 15, wherein the top mount housing is comprised of high pressure die cast aluminum or cold forged aluminum.

20. The method of claim 15, including disposing a damper mount within the upper portion.
